(19) United States
(12) Patent Application Publication
(10) Pub. No.: US 2005/0125356 A1
(43) Pub. Date: Jun. 9, 2005

(54) Method and apparatus for decrypting encrypted data by suing copy control information and computer readable recording medium for storing program for implementing the apparatus and method

(75) Inventors: Hee-chul Han, Suwon-si (KR); Yun-sang Kim, Suwon-si (KR); Yang-lim Chol, Seongnom-si (KR); Sung-hyu Han, Seoul (KR); Yong-kuk You, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/006,775

(22) Filed: Dec. 8, 2004

(30) Foreign Application Priority Data
Dec. 8, 2003 (KR) 2003-88773

(51) Int. Cl. H04L 9/00

(52) U.S. Cl. 705/57

(57) ABSTRACT

A method of decrypting encrypted data includes reading decryption control information representing decryptability of the encrypted data from an information storage, and changing the decryption control information into a decryptable condition by using a decryption coupon stored in a decryption device if the decryption control information indicates an undecryptable condition. Decryptability is additionally established in copy control information to increase data safety, enable various interactions with users, and facilitate access controls of the contents.

### BACKGROUND OF THE INVENTION

This application claims the priority of Korean Patent Application No. 2003-88773, filed on Dec. 8, 2003, in the Korean Intellectual Property Office, the disclosure of which is incorporated herein in its entirety by reference.

1. Field of the Invention

The present invention relates to digital data processing, and more particularly, to a method of and an apparatus for decrypting encrypted data.

2. Description of the Related Art

Digital data are used in a variety of fields such as digital media, networks, and computing devices. Since digital data can be repeatedly copied without any quality degradation, in communication systems such as computer networks and remote communication systems, they need to be encrypted and then delivered to allow only authorized users to use the data, for the purpose of data security and management. In addition, digital data are encrypted and then stored in a data storage medium in order to allow only authorized users to use the data.

However, if an authorized user decrypts the encrypted data by using a decryption key and then copies and distributes the decrypted data, unauthorized users can use the decrypted data freely. In this case, data providers may suffer an irreparable loss.

Therefore, typically, information indicating that the data can be encrypted or allowed to be copied freely, i.e., CCI (copy control information), is added to the data and then provided to the users. However, since the CCI can not completely indicate that the encrypted data can be decrypted, complex processes for a decryption control need to be prepared in a reproducing step.

### SUMMARY OF THE INVENTION

Accordingly, the present invention provides a method of and an apparatus for decrypting encrypted data in which decryptability information of the encrypted data is added to the encrypted data, so that data safety can be increased and various interactions with users can be made to create a new business model, and a computer readable recording medium storing a program for implementing the method of decrypting the encrypted data.

According to an exemplary aspect of the present invention, there is provided a method of decrypting encrypted data comprising steps of: reading out decryption control information representing decryptability of the encrypted data from an information storage medium; and changing the decryption control information into a decryptable condition by using a decryption coupon stored in a decryption device if the decryption control information indicates an undecryptable condition.

According to another exemplary aspect of the present invention, there is provided an apparatus for decrypting encrypted data comprising: a reader which reads out encrypted data and decryption control information representing decryptability of the encrypted data from an information storage medium; a coupon storage unit which stores the decryption coupon for the encrypted data; a decryption information changing unit which changes a condition of the decryption control information into a decryptable condition by using the decryption coupon stored in the coupon storage unit if the decryption control information indicates an undecryptable condition; and a data decryption unit which decrypts the encrypted data if the decryption control information indicates a decryptable condition.

According to still another exemplary aspect of the present invention, there is provided a computer readable recording medium which stores a program for implementing steps of: reading out decryption control information representing decryptability of encrypted data from an information storage medium; and changing a condition of the decryption control information into a decryptable condition by using a decryption coupon stored in a decryption device if the decryption control information indicates an undecryptable condition.

### BRIEF DESCRIPTION OF THE DRAWINGS

The above and other features and advantages of the present invention will become more apparent by describing in detail exemplary embodiments thereof with reference to the attached drawings in which:

FIG. 1 is a CCI table specifying copy control information;

FIG. 2 is a schematic diagram showing how to process the copy control information;

FIG. 3 is a CCI table showing an exemplary embodiment of extended CCI including decryptability information;

FIG. 4 is a flowchart showing an exemplary embodiment of a method of decrypting encrypted data by using “decrypt never CCI”;

FIG. 5 is a CCI ID table showing an exemplary embodiment of a CCI ID;

FIG. 6 is a schematic diagram showing an exemplary embodiment of purchasing an encrypted CCI coupon by using both disc and device bindings;

FIG. 7 is a schematic diagram showing an exemplary embodiment of purchasing an encrypted CCI coupon by using only a disc binding;

FIG. 8 is a schematic diagram showing an exemplary embodiment of purchasing an encrypted CCI coupon by using only a device binding;

FIG. 9 is a schematic diagram showing an exemplary embodiment of purchasing an encrypted CCI coupon by using a user's public key;

FIG. 10 is a schematic diagram showing an exemplary embodiment of a method of providing contents by using “decrypt never CCI”; and

FIG. 11 is a schematic diagram showing an exemplary embodiment of a method of providing contents when a coupon is provided by changing a user's level.

### DETAILED DESCRIPTION OF THE INVENTION

To fully understand advantages of the present invention, operation thereof, and objects to be attained by exemplary embodiments of the present invention, the accompanying drawings illustrating exemplary embodiments of the present invention and contents described in the accompanying drawings should be referred to.

Hereinafter, exemplary embodiments of the present invention will be described with reference to the accompanying drawings to explain the present invention in detail. The same elements in the drawings are indicated by the same reference numerals.

In digital data, particularly, AV (audio and/or video) data streams, CCI (copy control information) representing copyability is included to allow only authorized users to use contents.

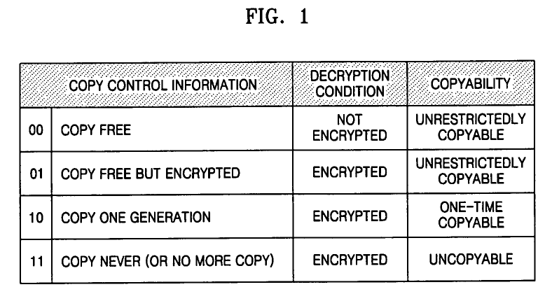

FIG. 1 is a CCI table showing an exemplary meaning of CCI.

The CCI is composed of 2 bit codes so that 4 modes can be set. In other words, one of modes “copy free,” “copy free but encrypted,” “copy one generation,” and “copy never” (or “no more copy”) can be set.

If the CCI is set to the mode “copy free,” the contents are not encrypted, and they are unrestrictedly and freely copyable.

If the CCI is set to the mode “copy free but encrypted,” the contents are encrypted, but they are unrestrictedly copyable.

If the CCI is set to the mode “copy one generation,” the contents are encrypted, and they are one-time copyable. In other words, once the contents are copied, the CCI is set to “no more copy.”

If the CCI is set to the mode “copy never,” the contents are encrypted, and they are never copyable. The “no more copy” has the same meaning as the “copy never,” but particularly designates the case that the mode “copy one generation” is changed into the mode “copy never.”

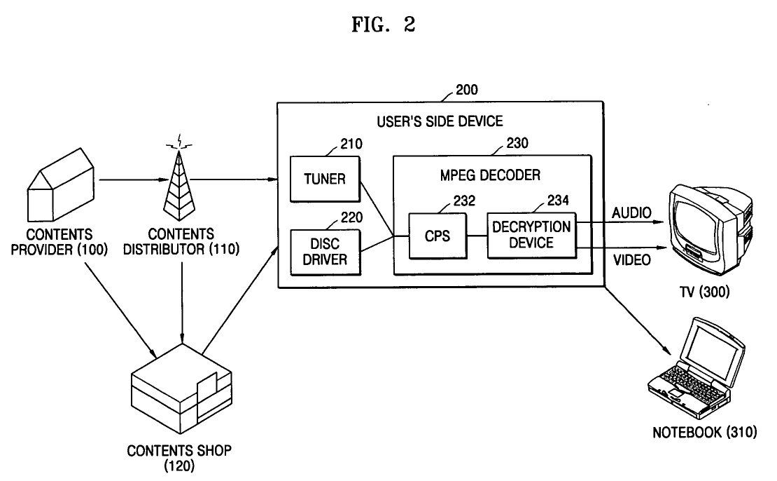

FIG. 2 shows how to process the CCI. A contents provider 100 or distributor 110 determines the CCI value and inserts the determined CCI into a header of the stream to be transmitted to a user's device 200. Then, a CPS (copy protection system) 232 within the user's device 200 translates the CCI for the transmitted data and performs processes corresponding to the contents in FIG. 1. When the operation to be processed by the user's device 200 corresponds with the CCI, a key needed for the decryption is provided to decrypt and reproduce the encrypted contents.

As described above, since the CCI indicates only whether or not the contents are encrypted and copyable, it is impossible to represent decryptability, and a separate complex method is needed for a decryption control. Therefore, the present invention provides a method of providing extended copy control information including decryptability information together with the encrypted contents.

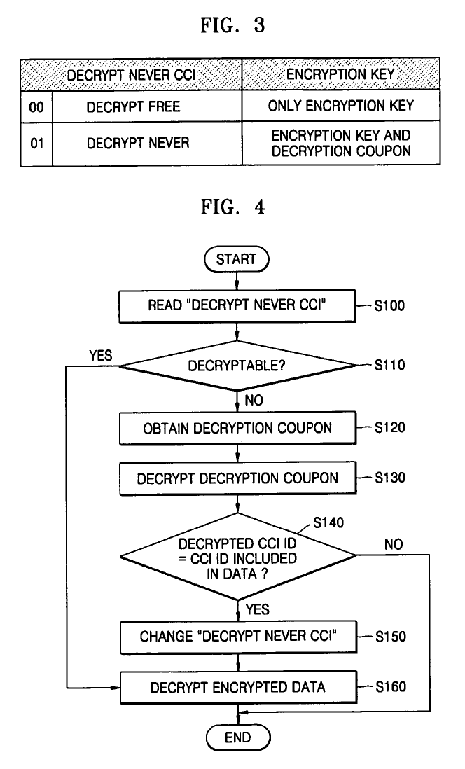

FIG. 3 shows a CCI table showing an exemplary embodiment of the extended CCI including decryptability information.

The decryptability information added to the extended CCI has two modes: “decrypt free” and “decrypt never.” Hereinafter, the decryptability-added CCI is referred to as “decrypt never CCI” for convenience of description.

If the “decrypt never CCI” is set to the mode “decrypt free,” the corresponding contents are encrypted by using only an encryption key, so that copyability is determined by CCI values except for the “decrypt never CCI.”

If the “decrypt never CCI” is set to the mode “decrypt never,” the corresponding contents are encrypted by using an encryption key and a decryption coupon which is necessary to decrypt the contents. Therefore, the functions intended in the present invention can be achieved when the added CCI according to the present invention is set to the mode “decrypt never,” thus calling it “decrypt never CCI.”

FIG. 4 is a flowchart showing an exemplary embodiment of a method of decrypting the encrypted data by using the “decrypt never CCI.”

First, the “decrypt never CCI” stored in an information storage medium is read out (S100). Then, it is determined if the “decrypt never CCI” is set to the mode “decrypt free” (S110). If the “decrypt never CCI” is set to the mode “decrypt free,” a decryptable condition exists and the encrypted data are decrypted (S160).

If the “decrypt never CCI” is set to the mode “decrypt never,” an undecryptable condition exists and the value of the “decrypt never CCI” is changed by using a decryption coupon in the decryption device (S150).

If the decryption coupon is not stored in the decryption device, a procedure for acquiring the decryption coupon is initiated (S120). The decryption coupon can be acquired by purchasing and downloading it from a decryption coupon selling server, reading it out from an information storage medium storing the decryption coupon, or buying it at a contents shop 120 shown in FIG. 2 and then inputting it to the decryption device.

Also, the decryption coupon can be created by encrypting a CCI ID (copy control information identification). In this case, the decryption coupon is referred to as a “CCI coupon.”

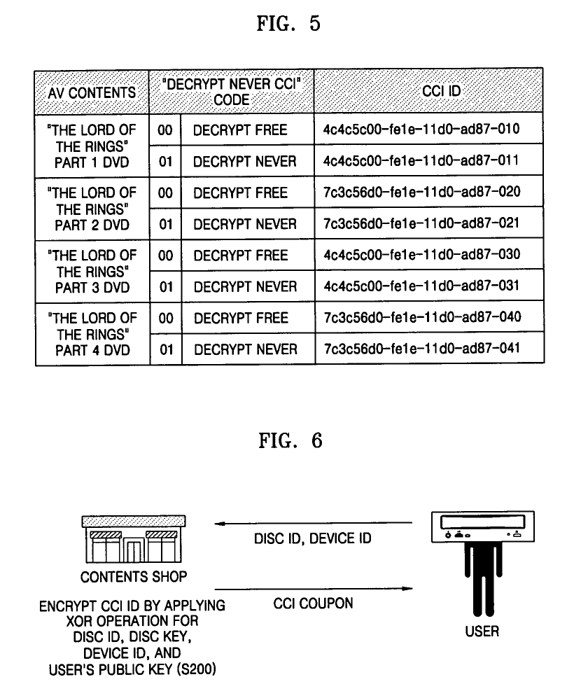

FIG. 5 is a CCI ID table showing an exemplary embodiment of the CCI ID.

The CCI ID is a combination of characters and numbers. The CCI ID includes the “decrypt never CCI,” and, particularly in FIG. 5, the last symbol of the CCI ID represents the “decrypt never CCI.”

Therefore, the CCI IDs in FIG. 5 are same for the same AV contents, except portions representing the “decrypted never CCI.”

Security of data encryption can be further increased if the decryption coupon is decrypted and complex processes are needed to obtain a key during the step of obtaining the CCI ID. For this purpose, information uniquely given to each disc can be used during an encryption step, or information uniquely given to each device can be used. In this case, the scheme using the information uniquely given to each disc is referred to as a “disc binding” scheme, and the scheme using the information uniquely given to each device is referred to as a “device binding” scheme. In addition, information uniquely given to each user can be also used.

The information uniquely given to each disc includes a disc ID or a disc key, and the information uniquely given to each device includes a device ID. In addition, the information given to each user includes a user's public key used in a public key algorism.

FIG. 6 shows an exemplary embodiment of a method of purchasing an encrypted CCI coupon by using both the disc and device binding schemes.

A result of an exclusive OR operation for the disc ID, the disc key, the device ID, and the user's public key is used as an encryption key (S200). In this case, the CCI coupon can be decrypted only when the disc having the disc information used for the encryption and the device having the device information used for the encryption are used.

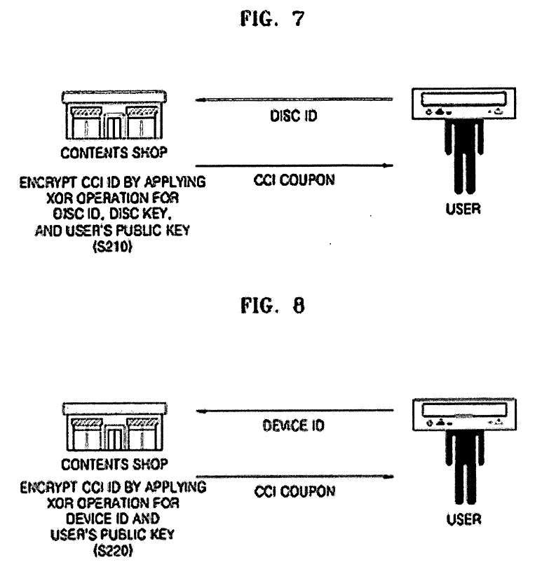

FIG. 7 shows an exemplary embodiment of a method of purchasing an encrypted CCI coupon by using only the “disc binding” scheme.

When only the “disc binding” scheme is used, a result of an exclusive OR operation for the disc ID, the disc key, and the user's public key is used as an encryption key (S210). In this case, the CCI coupon can be decrypted only when the disc having the disc information used for the encryption is used.

FIG. 8 shows an exemplary embodiment of a method of purchasing an encrypted CCI coupon by using only the “device binding” scheme.

When only the “device binding” scheme is used, a result of an exclusive OR operation for the device ID and the user's public key is used as an encryption key (S220). In this case, the CCI coupon can be decrypted only when the device having the device ID used for the encryption is used.

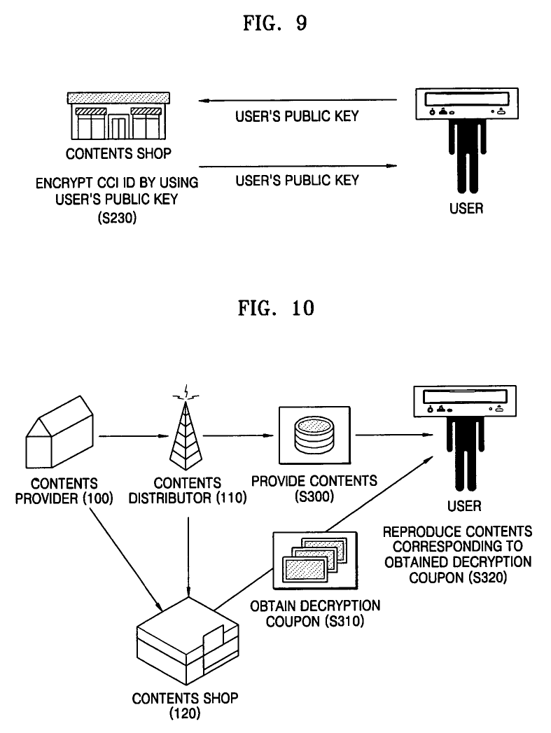

FIG. 9 shows an exemplary embodiment of a method of purchasing an encrypted CCI coupon by using only the user's public key.

When the CCI coupon is encrypted by using only the user's public key (S230), the user can decrypt the CCI coupon by using the user's own secret key.

Referring to FIG. 4, a method of changing the value of the “decrypt never CCI” by using a decryption coupon will be described as follows.

In order to obtain the CCI ID, the CCI coupon is decrypted (S130). At this point, the key used for the decryption is an encryption key used to create the coupon or the corresponding decryption key. The information used for creating the encryption key is also used for creating the decryption key.

The CCI ID obtained by decrypting the CCI coupon is compared with the CCI ID included in the encrypted data (S140). If corresponding portions of both CCI IDs, i.e., the portions except for the “decrypt never CCI,” are the same, the “decrypt never CCI” value is changed into “decrypt free” (S150), and the encrypted data are decrypted (S160).

If the corresponding portions of both CCI IDs are not the same, the data can not be decrypted because the CCI coupon is not appropriate.

Now, a new business model using the “decrypt never CCI” will be described.

FIG. 10 shows an exemplary embodiment of a method of providing contents by using the “decrypt never CCI.”

A contents provider 100 or distributor 110 provides encrypted contents, of which “decrypt never CCI” is set to the mode “decrypt never,” to users for free (S300). Conventionally, the selling items are the encrypted contents not a “decryption coupon.” On the contrary, according to the present invention, the data having the “decrypt never CCI” are not necessary to be paid when the data is provided.

The contents may be transmitted to users by broadcasting, the Internet, or discs. Even if the users are provided with the contents for free, they can not reproduce the contents. In other words, when a user is attempting to reproduce them, the reproducing device requires the decryption coupon to be downloaded or input by the user, or a disc storing the coupon to be inserted.

In this case, in order to purchase the decryption coupon, the user may get an access to a decryption coupon selling server through a user's interface provided by the reproducing device. Also, the user may purchase the decryption coupon or a disc storing the coupon at a contents shop 120 (S310).

This will provide following marketing advantages. If a user has the encrypted contents in advance, she/he has a strong impulse to know what the contents are. In other words, a user has a stronger impulse to purchase a decryption coupon when she/he already possesses the contents that has not been decrypted than to purchase the contents that has not been encrypted in advance.

In addition, different contents can be encrypted according to user's levels, and coupons corresponding to the levels can be issued.

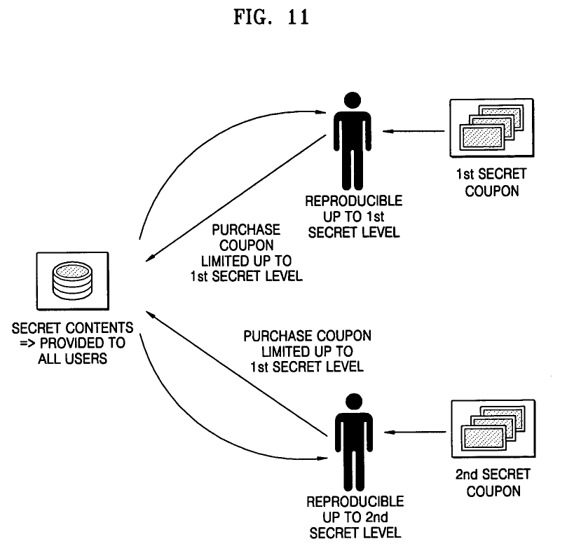

FIG. 11 shows an exemplary embodiment of a method of providing contents when the coupon is provided according to user's levels.

A contents provider 100 or distributor 110 provides the encrypted contents, of which “decrypt never CCI” is set to the mode “decrypt never,” to users for free. In this case, the encrypted contents include a plurality of CCI IDs and the “decrypt never CCI” corresponding to each CCI ID.

If a user purchases a coupon having an access limitation up to 2nd secret level, only the corresponding “decrypt never CCI” is allowed to be changed into the mode “decrypt free.” In this case, the user cannot reproduce the portions set to 1st secret level. Particularly, this can be useful when limitedly accessible contents are provided to persons under a certain age. For example, if the contents are made into two versions: a juvenile inhibited version and a juvenile admitted version, the “decrypt never CCI” can be differently set for different versions, so that the decryption can be easily controlled.

In addition, if an access needs to be controlled only for a part of the contents (this case is called “walled garden”), conventionally, different keys are used to control accesses for different contents. However, there may be problems in the key management. In this case, “decrypt never CCI” of the present invention will make it possible to implement an access control effectively.

The present invention can be applied to all kinds of digital appliances for storing and/or reproducing AV data streams.

The present invention can be implemented as computer readable codes stored in a computer readable recording medium. The computer includes all kinds of data processing devices, particularly including user's terminals. The computer readable recording medium includes all kinds of recording devices storing computer readable data, such as ROMs, RAMs, flash memories, magnetic storages including floppy discs, hard discs, and magnetic tapes, optical storage media including CD-ROMs and DVDs, and carrier waves including the internet transmission.

According to the method of and apparatus for decrypting encrypted data of the present invention, decryptability information is additionally established in the copy control information, so that data safety can be increased, various interactions can be made with users, and an access control can be facilitated for the contents.

Exemplary embodiments of the present invention are disclosed in the drawings and the specification, as described above. In addition, although specific terms have been used hereto, the terms are intended to explain the present invention, but not intended to limit a meaning or restricting the scope of the present invention written in the following claims. Accordingly, it will be understood by those of ordinary skill in the art that various changes in form and details may be made therein without departing from the spirit and scope of the present invention as defined by the following claims.

1. A method of decrypting encrypted data comprising:
(a) reading out decryption control information on decryptability of the encrypted data from an information storage medium; and
(b) changing a condition of the decryption control information into a decryptable condition by using a decryption coupon stored in a decryption device if the decryption control information indicates an undecryptable condition.

2. The method according to claim 1, wherein the decryption control information is established in copy control information.

3. The method according to claim 1, further comprising
(c) if the decryption coupon is not stored in the decryption device, accessing a decryption coupon selling server, purchasing the decryption coupon, and storing the decryption coupon in the decryption device.

4. The method according to claim 1, further comprising
(c) if the decryption coupon is not stored in the decryption device, receiving a user's input for the decryption coupon and storing the decryption coupon in the decryption device.

5. The method according to claim 1, further comprising
(c) if the decryption coupon is not stored in the decryption device, reading out the decryption coupon from the information storage medium and storing the decryption coupon in the decryption device.

6. The method according to claim 1, wherein the encrypted data includes encrypted digital contents.

7. The method according to claim 1, wherein the decryption coupon is created by encrypting a copy control information identification uniquely given to the encrypted data by using a predetermined encryption key.

8. The method according to claim 7, wherein the copy control information identification is a combination of characters and numbers.

9. The method according to claim 8, wherein a last symbol of the copy control information identification is a number representing the decryption control information.

10. The method according to claim 7, wherein the predetermined encryption key is created by applying an exclusive OR operation for a medium identification uniquely given to the information storage medium, a medium key uniquely given to the information storage medium, and a device identification uniquely given to the decryption device.

11. The method according to claim 7, wherein the predetermined encryption key is a user's public key uniquely given to the user.

12. The method according to claim 7, wherein the predetermined encryption key is created by applying an exclusive OR operation for a device identification uniquely given to the decryption device and a user's public key uniquely given to the user.

13. The method according to claim 7, wherein the predetermined encryption key is created by applying an exclusive OR operation for a medium identification uniquely given to the information storage medium, a medium key uniquely given to the information storage medium, and a user's public key uniquely given to the user.

14. The method according to claim 1, wherein (b) comprises:
(b-1) decrypting the decryption coupon to obtain a copy control information identification;
(b-2) comparing the decrypted copy control information identification and a copy control information identification included in the encrypted data; and
(b-3) changing a condition of the decryption control information into a decryptable condition if corresponding portions of both the copy control information identifications are the same.

15. An apparatus for decrypting encrypted data comprising:
a reader which reads out encrypted data and decryption control information on decryptability of the encrypted data from an information storage medium;
a coupon storage unit which stores a decryption coupon for the encrypted data;
a decryption information changing unit which changes a condition of the decryption control information into a decryptable condition by using the decryption coupon stored in the coupon storage unit if the decryption control information indicates an undecryptable condition; and
a data decryption unit which decrypts the encrypted data if the decryption control information indicates a decryptable condition.

16. The apparatus according to claim 15, wherein the decryption control information is established in copy control information.

17. The apparatus according to claim 15, further comprising
a coupon purchasing unit which, if the decryption coupon is not stored in the coupon storage unit, accesses a decryption coupon selling server, purchases the decryption coupon, and stores the decryption coupon in the coupon storage unit.

18. The apparatus according to claim 15, further comprising
a coupon input unit which, if the decryption coupon is not stored in the coupon storage unit, receives a user's input for the decryption coupon and stores the decryption coupon in the coupon storage unit.

19. The apparatus according to claim 15, wherein the reader comprises a coupon reader which, if the decryption coupon is not stored in the coupon storage unit, reads out the decryption coupon from the information storage medium and stores the decryption coupon in the coupon storage unit.

20. The apparatus according to claim 15, wherein the encrypted data includes encrypted digital contents.

21. The apparatus according to claim 15, wherein the decryption coupon is created by encrypting a copy control information identification uniquely given to the encrypted data by using a predetermined encryption key.

22. The apparatus according to claim 21, wherein the copy control information identification is a combination of characters and numbers.

23. The apparatus according to claim 22, wherein a last symbol of the copy control information identification is a number representing, the decryption control information.

24. The apparatus according to claim 21, wherein the predetermined encryption key is created by applying an exclusive OR operation for a medium identification uniquely given to the information storage medium, a medium key uniquely given to the information storage medium, and a device identification uniquely given to the decryption device.

25. The apparatus according to claim 21, wherein the predetermined encryption key is a user's public key uniquely given to the user.

26. The apparatus according to claim 21, wherein the predetermined encryption key is created by applying an exclusive OR operation for a device identification uniquely given to the decryption device and a user's public key uniquely given to the user.

27. The apparatus according to claim 21, wherein the predetermined encryption key is created by applying an exclusive OR operation for a medium identification uniquely given to the information storage unit, a medium key uniquely given to the information storage medium, and a user's public key uniquely given to the user.

28. The apparatus according to claim 15, wherein the decryption information changing unit comprises:
a coupon decryption unit which decrypts the decryption coupon to obtain a copy control information identification; and
a copy control information identification comparator unit which compares the decrypted copy control information identification with a copy control information identification included in the encrypted data and changes a condition of the decryption control information into a decryptable condition if corresponding portions of both the copy control information identifications are the same.

29. A computer readable recording medium which stores a program for implementing:
reading out decryption control information representing decryptability of encrypted data from an information storage medium; and
changing a condition of the decryption control information into a decryptable condition by using a decryption coupon stored in a decryption device if the decryption control information indicates an undecryptable condition.

30. Audio/video (AV) data including copy control information, wherein the AV data comprises:
first copy control information representing an encryption condition and copyability of the AV data; and
second copy control information representing decryptability of the AV data.

31. The audio/video data according to claim 30, wherein the first copy control information represents one of:
a fist mode which indicates that the AV data are not encrypted and freely copyable;
a second mode which indicates that the AV data are encrypted and freely copyable;
a third mode which indicates that the AV data are encrypted and one-time copyable; and
a fourth mode which indicates that the AV data are encrypted and uncopyable.

32. The audio/video data according to claim 30, where the second copy control information represents one of:
a first mode in which the AV data are decryptable; and
a second mode in which the AV data are undecryptable.

33. The audio/video data according to claim 32, wherein in the second mode, a device by which the AV data is to be reproduced decrypts the AV data using a predetermined decryption key and a decryption coupon for changing a condition of the second copy control information into the first mode.
